(19) United States
(12) Patent Application Publication
(10) Pub. No.: US 2015/0258472 A1
(43) Pub. Date: Sep. 17, 2015

(54) Partitioned Separator Water Treatment System with Upflow Filter

(71) Applicant: Zachariha Kent, Oceanside, CA (US)

(72) Inventor: Zachariha Kent, Oceanside, CA (US)

(21) Appl. No.: 14/217,258

(22) Filed: Mar. 17, 2014

(51) Int. Cl. B01D 29/52

(52) U.S. Cl. CPC B01D 29/52

(57) ABSTRACT

A system designed to control and filter runoff water in storm drains is presented. Drain water frequently carries trash, organic matter, suspended solids, hydrocarbons, metals, nutrients and bacteria collected from streets and parking lots into a storm drain inlet, which enters storm water drain pipe systems.

The present invention supplies a series of baffle boxes inserted in the drain water stream with a final box possessing an upflow filter comprising filtration media. The system can also support a storm flow bypass that directs high-flow storm runoff water directly to the outlet to protect the filter system.

### PRIORITY DATA

The present application claims the benefit of U.S. Provisional Patent Application Ser. No. 61/902,625, which is hereby incorporated by reference in its entirety and which was filed on Nov. 11, 2013.

### FIELD OF THE INVENTION

This invention relates to the fields of water filtration systems and storm water control systems.

### BACKGROUND OF THE INVENTION

The present invention is designed to control and filter runoff water in storm drains. Drain water frequently carries trash, organic matter, suspended solids, hydrocarbons, metals, nutrients and bacteria collected from paved surfaces and other areas into a storm drain inlet, then sent into a storm water drain pipe system. Drain water often carries oil collected from the streets.

Various water bodies including ponds, rivers, and oceans can tolerate a certain amount of pollutant loading, but the amount allowed to flow into these collection areas should be minimized. The present invention is an in-line storm water drain filter system having a series of separation chambers for removing larger material followed by an upflow filter for smaller and dissolved material. The filter box is installed in connection with a storm water drain pipe; this pipe directs drain water through the separation chambers and upflow filter to the storm water drain passing through an outfall into a lake, pond or retention area. There is an upflow filter between the separation chambers and the outflow to address collection of fine particulates and organics. A hydrocarbon collecting boom in a cage is placed at the last separation baffle on the influent side to absorb hydrocarbons.

### SUMMARY OF THE INVENTION

The inline partitioned separator and upflow filter system is installed inline with the drain water flow path, and can be buried underground with access ports. The filter system includes a housing having an inlet and an outlet and a plurality of separation chambers formed therein. The separation chambers collect various densities of sediment for later cleaning. A housing cover allows access into the housing and a plurality of separation chambers and media cages.

An oil collection boom is removably mounted on one or more of the baffles near the outlet for collecting hydrocarbons in the drain water entering the system.

The separation chambers closest to the outflow are each equipped with an upflow filter. The upflow filter has two main components: the filter housing and the filter media. The filter housing is constructed of a cage that holds the media. It has top doors that open to allow the media to be changed out.

The media is a filter that removes fine TSS, nutrients, metals, bacteria, and emulsified hydrocarbons from the drain water as it flows upward through the last separation chamber.

One of the unique features of this system is that fall between the inflow and outflow pipes is not necessary as with downward flow systems. The internal weir, located on the side of the upflow filter opposite of the outflow pipe allows water pressure to build behind it which drives water through the upflow filter.

A standard 2 chambered separator works well enough to provide the necessary drain water pretreatment to prevent larger particles and solid pollutants from prematurely clogging the upflow filter.

### BRIEF DESCRIPTION OF THE FIGURES

FIG. 1. Cut-out, side view of an embodiment of the invention in low flow configuration.

FIG. 2. Cut-out, side view an embodiment of the invention in high flow configuration.

FIG. 3. Cut-out, side view of an embodiment of the invention in low flow configuration.

FIG. 4. Cut-out, side view of an embodiment of the invention in low flow configuration.

FIG. 5. Cut-out, side view of an embodiment of the invention in low flow configuration.

FIG. 6. Cut-out, outflow-end view of an embodiment of the invention.

### DETAILED DESCRIPTION OF THE INVENTION

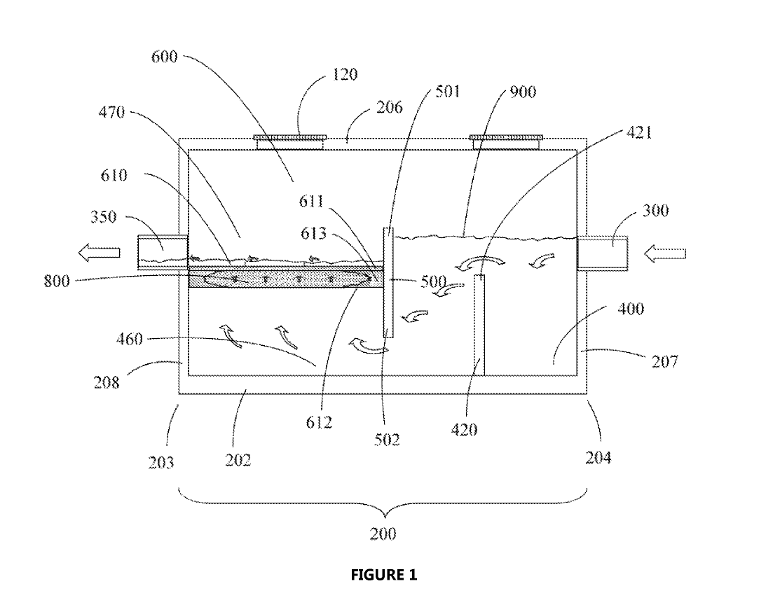

Referring to FIG. 1, a cut-out, side view of an embodiment of a partitioned separator water treatment system with an upflow filter assembly is shown. The system comprises rectangular box 200 having inflow end 204 that comprises inflow opening 300 in inflow end wall 207 and outflow end 203 that comprises outflow opening 350 in outflow end wall 208. Inflow opening 300 is configured to receive water from stormwater conveyance system infrastructure, such as pipes or channels. Box 200 comprises primary separation chamber 400 and secondary separation chamber 460, established by separation chamber weir 420. Separation chamber weir 420 is in sealed connection with floor 202 and lateral walls (not shown) of box 200, but not the ceiling 206 of box 200. The top of primary separation chamber weir 421 is positioned below the bottom of intake opening 300. This configuration results in water entering inflow opening 300, filling primary separation chamber 400, and flowing over the top of primary separation chamber weir 421 into secondary separation chamber 460. In the process, sufficiently dense and heavy waterborne sediment and debris is deposited in primary separation chamber 400 for later removal. Box 200 possesses access hatches comprised of openings in ceiling 206 of and removable covers 121.

The system further possesses a bypass weir and an upflow filter assembly. The upflow filter assembly comprises media filtration unit 610. Media filtration unit 610 is in sealed connection with outflow end wall 208, lateral walls (not shown) of box 200, and bypass weir 500. Bypass weir 500 is in sealed connection with lateral walls (not shown) of box 200, but not the floor 202 or the ceiling 206 of box 200. Media filtration unit 610 is configured to permit water to flow from secondary separation chamber 460 into outflow chamber 470 only by passing through media filtration unit 610.

Media filtration unit 610 comprises top panel 611 made of strong, durable material(s) such as metal or plastic in a water permeable configuration capable of inhibiting the passage of filtration media 800 therethrough, such as grate or screen configurations. Top panel 611 is sealingly fitted to solid side walls 613 (the central region of which is not illustrated to show filtration media 800) of media filtration unit 610. Media filtration unit 610 comprises bottom panel 612 made of strong, durable material(s) such as metal or plastic in a water permeable configuration capable of and inhibiting the passage of filtration media 800 therethrough, such as grate or screen configurations. The water permeable configurations of top panel 611 and bottom panel 612 are operative to allow water to pass through media filtration unit 610 while simultaneously retaining filtration media 800 in media filtration unit 610. Media filtration unit 610 is loaded with inorganic filtration media 800 such as zeolite, expanded aggregates, lava rock, oxide-coated inert material, alumina, activated carbon, perlite, stonewool, rockwool, and pumice. Media filtration unit 610 is operative to remove, from water flowing therethrough, waterborne particulate matter such as fine sediments and particulates and dissolved pollutants.

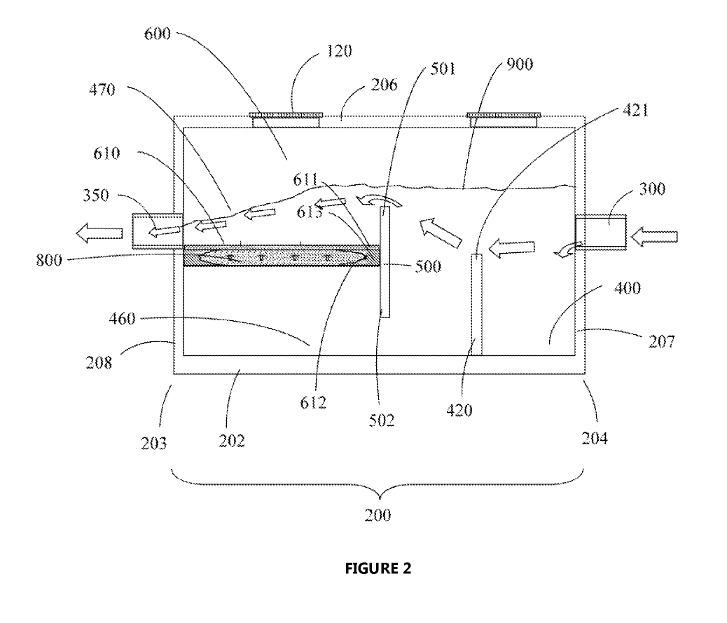

In the process of performing its filtration functions, the upflow filter assembly impedes the flow of water from secondary separation chamber 460 into outflow chamber 470. This impedance makes possible conditions in which water enters inflow opening 300 at a rate greater than it flows from secondary separation chamber 460 into outflow chamber 470. Under such conditions, the water level 900 can rise in the portion of box 200 frontward of bypass weir 500 to the point where water flows over the top 501 of bypass weir 500, into outflow chamber 470, and out outflow opening 350, as shown in FIG. 2.

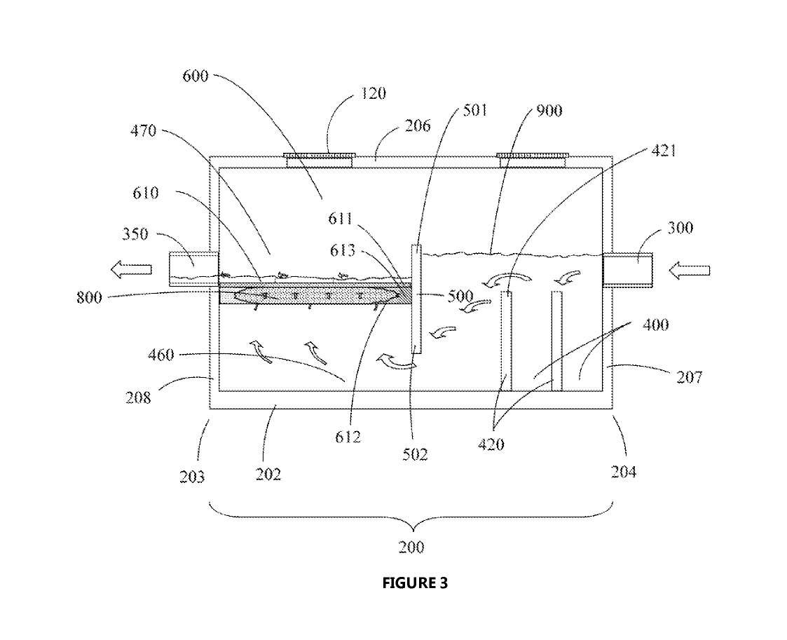

FIG. 3 shows a cut-out, side view of an embodiment of a partitioned separator water treatment system with an upflow filter assembly that differs from the embodiment illustrated in FIG. 1 by comprising a second separation chamber weir 420 and a second primary separation chamber 400.

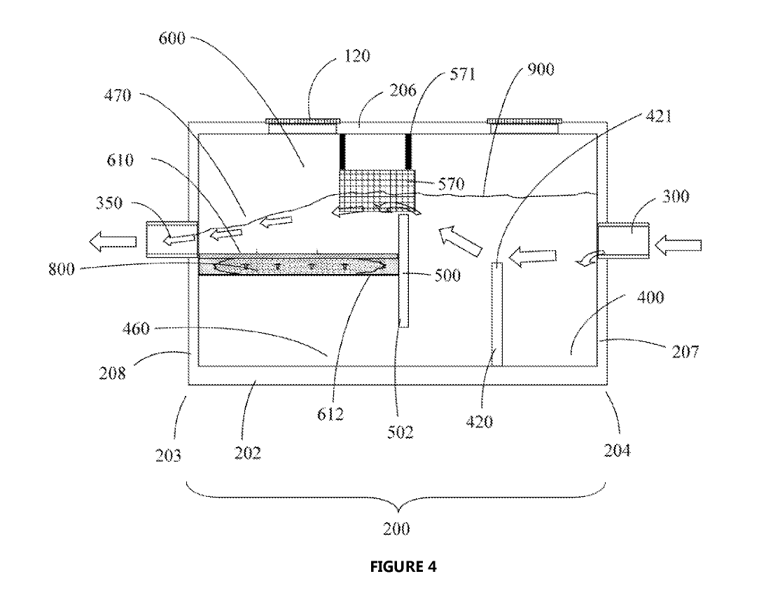

FIG. 4 shows a cut-out, side view of an embodiment of a partitioned separator water treatment system with an upflow filter assembly that differs from the embodiment illustrated in FIG. 1 by comprising a bypass filtration basket 570 suspended in proximity with bypass weir 500 by posts 571 extending from ceiling 206 of box 200.

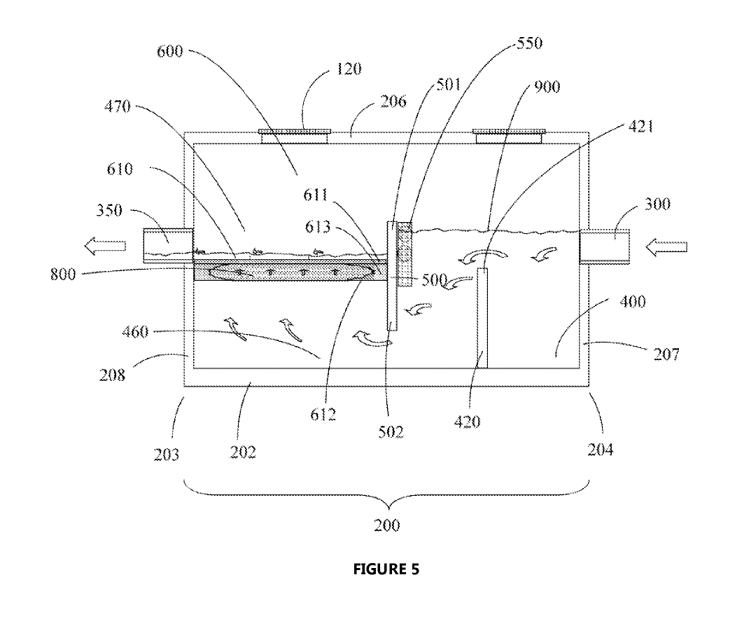

FIG. 5 shows a cut-out, side view of an embodiment of a partitioned separator water treatment system with an upflow filter assembly that differs from the embodiment illustrated in FIG. 1 by comprising a hydrocarbon filtration unit 550 mounted on bypass weir 500.

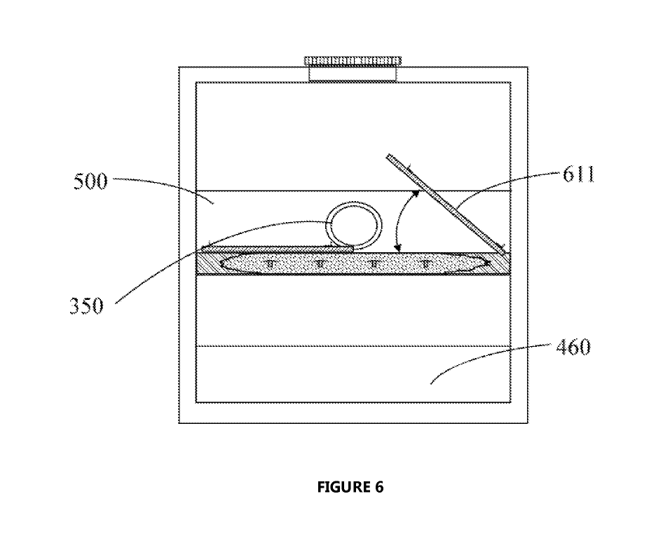

FIG. 6 shows a cut-out, outflow-end view of an embodiment of a partitioned separator water treatment system with an upflow filter assembly in which a section of top panel 611 of media filtration unit 610 is configured as an openable hatch that provides access to the center of media filtration unit 610 for purposes of loading and removing filtration media 800.

The content of U.S. Pat. No. 8,496,618 is hereby incorporated by reference in its entirety.

The apparatus and methods described are the preferred and alternate embodiments of this invention, but other methods are possible and are within the contemplation of this patent.

What is claimed is:

1. A partitioned separator water treatment system, comprised of a box configured for insertion into a flow stream, the box possessing a ceiling, a floor, two lateral walls, an inflow endwall comprising an inflow opening and an outflow endwall comprising an outflow opening,
the inflow end of the box possessing at least one separation chamber weir dividing the box into a plurality of separation chambers, the at least one separation chamber weir in sealing connection with the floor and two lateral walls of the box, but not the ceiling of the box, and having a top below a bottom level of the inflow opening,
the box and the at least one separation chamber weir situated such that water entering the inflow opening is capable of filling the plurality of separation chambers and flowing over the top(s) of the at least one separation chamber weir, allowing sediment and solid pollutants to be trapped in the plurality of separation chambers,
the outflow end of the box possessing a bypass weir in sealing connection with an upflow filter assembly that comprises a media filtration unit,
the bypass weir: i. in sealing connection with the lateral walls of the box, but not the floor or the ceiling of the box, ii. having a top that is above the top of the at least one separation chamber weir, and iii. having a bottom that is above the floor of the box, such that water entering the inflow opening is capable of flowing toward the outflow opening below the bypass weir during low flow periods and above and below the bypass weir during high flow periods,
the media filtration unit in sealing connection with the lateral walls of the box and possessing: i. a top panel that is water permeable and positioned below a bottom level of the outflow opening, ii. a bottom panel that is water permeable, iii. side walls that are water impermeable, and iv. filtration media between the top panel, the bottom panel, and within the side walls, such that water is permitted to flow from an area in the box below the media filtration unit, upward to the outflow opening only by passing through the filtration media,
the filtration media capable of removing, from water that flows therethrough, fine sediments and particulates and dissolved pollutants.

2. The partitioned separator water treatment system of claim 1, further comprising a hydrocarbon filtration unit mounted on a side of the bypass weir that faces the inflow endwall.

3. The partitioned separator water treatment system of claim 1, further comprising a bypass filtration basket mounted on a side of the bypass weir that faces the outflow endwall.

4. The partitioned separator water treatment system of claim 1, wherein the filtration media is a least one inorganic media selected from the group consisting of a zeolite, an expanded aggregate, a lava rock, an oxide-coated inert material, an alumina, an activated carbon, a perlite, a stonewool, a rockwool, and a pumice.

5. The partitioned separator water treatment system of claim 1, wherein the inflow opening is on one or more of the three walls on the inflow side of the bypass weir.

6. The partitioned separator water treatment system of claim 1, wherein the outflow opening is on one or more of the three walls on the outflow side of the bypass weir.
